(19) United States
(12) Patent Application Publication
(10) Pub. No.: US 2018/0043361 A1
(43) Pub. Date: Feb. 15, 2018

(54) ANALYSIS DEVICE FOR A LIQUID SAMPLE

(71) Applicants: CSIC, Madrid (ES); ICREA, Barcelona (ES); FUELIUM, Barcelona (ES)

(72) Inventors: Maria de les Neus Sabate Vizcarra, Cerdanyola del Valles Barcelona (ES); Juan Pablo Esquivel Bojorquez, Cerdanyola del Valles Barcelona (ES); Sergi Gasso-Pons, Barcelona (ES)

(73) Assignees: Consejo Superior de Investigaciones Cientificas (CSIC), Madrid (ES); Institucio Catalana de Recerca i Estudis Avancats (ICREA), Barcelona (ES); FUELIUM, Barcelona (ES)

(21) Appl. No.: 15/790,942

(22) Filed: Oct. 23, 2017

Related U.S. Application Data
(63) Continuation-in-part of application No. 14/409,897, filed on Dec. 19, 2014.

(30) Foreign Application Priority Data
Jun. 20, 2012 (ES) P201230960

(51) Int. Cl. B01L 3/00; H01M 8/1286; G01J 1/04; H01M 8/16; H01M 8/04082

(52) U.S. Cl. CPC B01L 3/502715; B01L 3/502707; H01M 8/16; H01M 8/04216; G01J 1/0403; H01M 8/1286; H01M 8/1009

(57) ABSTRACT

An analysis device for a liquid sample comprising: one microfluidic analysis channel made of a wicking material with adequate porosity to allow capillary flow of at least one liquid sample suitable for generating electricity, at least one receiving absorbent region coupled to the microfluidic analysis channel, at least one collecting absorbent region coupled to the microfluidic analysis channel, a cathodic zone coupled to the microfluidic analysis channel, an anodic zone coupled to the microfluidic analysis channel, and at least one detection zone having a sensor, where each receiving absorbent region and each collecting absorbent region are coupled to the microfluidic analysis channel such that when a fluid suitable for generating electricity is deposited in the receiving absorbent region, it flows by capillary action through the microfluidic analysis channel to reach the collecting absorbent region where it is absorbed, and where the sensor interacts with the sample when the latter flows by capillary through the microfluidic analysis channel.

### CROSS-REFERENCE TO RELATED APPLICATIONS

This application is a Continuation-in-Part of U.S. application Ser. No. 14/409,897, filed on Dec. 19, 2014, the content of which is hereby incorporated by reference in its entirety, which is the national stage entry of International Application No. PCT/EP2013/062718, filed on Jun. 19, 2013, the entire disclosures of which are incorporated herein by reference, which claims priority to Spanish Application No. P201230960, filed on Jun. 20, 2012.

### TECHNICAL FIELD

The present invention is directed, in general, to the field of analysis devices. In particular, the invention relates to an analysis device for a liquid sample. Although preferably the sample to be analysed is a liquid, that it may contain suspended particles, the invention can also analyze a gas sample or a gel.

### BACKGROUND OF THE INVENTION

A fuel cell is a device that converts chemical energy of a fuel into electrical energy, said conversion takes place as long as the fuel is supplied to the cell. These devices have been developed for more than a decade and have recently begun to find opportunities in, for example, medical applications.

Fuel cells differ from conventional batteries in that the fuel cells allow the continuous replenishment of the consumed reagents, i.e. producing electricity from an external source of fuel and oxygen as opposed to the limited capacity of energy storage which has a battery. In addition, the electrodes in a battery react and change according to how it is loaded or unloaded, whereas in a fuel cell electrodes are catalytic and relatively stable. Moreover, conventional batteries consume solid reactants, and once depleted, must be discarded or recharged with electricity. Generally, in a fuel cell the reagent(s) flow inwardly and the reaction products flow outwardly. This flow of reactant(s) is normally achieved by using, for example, external pumps, which may result in a complex and expensive configuration of the fuel cell.

For instance, U.S. 2009092882 A1 (Kjeang E. et al.) discloses a microfluidic fuel cell architecture with flow through the electrodes. The anode and cathode electrodes are porous and comprise a network of interstitial pores. A virtual insulator is located between the electrodes, in an electrolyte channel. The virtual insulator consists of a co-laminar flow of an electrolyte. An inlet directs substantially all the flow of the liquid reactant through the porous electrode. This configuration has the disadvantage of requiring means, e.g. an external pump, to provide the liquid reagent through the inlet for the fuel cell to operate.

Very recently, it has been disclosed that the integration of a micro direct methanol fuel cell can provide both pumping and electrical power to a microfluidics platform successfully [J P Esquivel, et al., Fuel cell powered microfluidic platform for lab on a chip applications, Lab on a Chip (2011) 12, 74-79]. The electrochemical reactions that take place in the fuel cell produce CO₂, which is normally considered a residue without any utility. In this case, however, the CO₂ is accumulated and used for pumping a fluid into the microfluidic platform. Therefore, the pumping of a fluid, which may be a reagent of a fuel cell, is achieved without need for an external pump, but it is necessary to use a methanol fuel cell for this purpose. Thus, in this case, also the obtained configuration is complex and expensive. Also, using a first fuel cell to cause a flow of a reagent of a second fuel cell would result in a complex system.

US2012288961 discloses a capillarity-based device that makes use of a flow-metering element and/or a volume-metering feature on a porous membrane to perform microfluidic analyses.

However, none of the quoted prior art discloses an analysis device including a single microfluidic analysis channel providing the functionalities of both analysis and detection.

### DESCRIPTION OF THE INVENTION

Embodiments of the present invention provide an analysis device for a liquid sample, preferably a biological sample such as blood, urine, sweat, saliva, tears, sperm, milk, juice, alcoholic drinks, water, etc., that comprises one microfluidic analysis channel made of a wicking material with adequate porosity to allow capillary flow of at least one liquid sample suitable for generating electricity; a receiving absorbent region coupled to said microfluidic analysis channel; a collecting absorbent region coupled to said microfluidic analysis channel; a cathodic zone formed by at least one cathode coupled to said microfluidic analysis channel; an anodic zone formed by at least one anode coupled to said microfluidic analysis channel; and a detection zone including a sensor connected to said microfluidic analysis channel.

In the proposed analysis device, the receiving absorbent region and the collecting absorbent region are connected to the microfluidic analysis channel, thereby when a liquid sample is deposited in the receiving absorbent region the liquid sample flows by capillary action through the microfluidic analysis channel to reach the collecting absorbent region where it is absorbed.

Besides, the sensor of the detection zone interacts with the liquid sample to be tested, or analyzed, when said sample flows by capillary through the microfluidic analysis channel.

The proposed analysis device by only having a single microfluidic analysis channel allows reducing the volume of the liquid sample required both to generate and to perform the analysis. Moreover, it comprises a simplified design and requires less amount of material required for its fabrication (in comparison with other analysis devices having different microfluidic channels). It also allows simplifying the fabrication processes leading to higher cost-effectivity of the analysis device.

The analysis device may comprise more than one receiving absorbent region coupled to the analysis microfluidic channel, in which case the different receiving absorbent regions can be totally independent or they may be separated regions and located on the same physical support, also called sub-regions in this patent application.

Besides, the receiving and collecting absorbent regions can be located at different heights, which facilitate the flow by capillary action through the microfluidic analysis channel.

In the present invention the term “suitable fluid to generate electricity” is understood as any fluid comprising at least one oxidizing or reducing substance, so that this fluid can interact with one of the cathodes or anodes to generate electricity. Preferably the fluid is a liquid, although it may contain suspended particles, or be a gas or a gel.

In addition to the appropriate flow to generate electricity, the analysis device of the present invention can also incorporate at least one electrolytic fluid in the receiving region(s) coupled to the microfluidic analysis channel. Preferably, this electrolytic fluid is placed in a receiving region different from the one(s) used to deposit any of the suitable fluids to generate electricity.

The analysis device of the present invention has the advantage that the flow of suitable fluids for generating electricity, i.e. the flow of reactants is achieved by capillary action and/or diffusion, eliminating the need of, for example, pumps or other means to flow these reactants. In this regard, one of the key points of the analysis device is that absorption by the collecting absorbent region causes the continuation of the flow by capillary action once the microfluidic analysis channel has become saturated. The proposed analysis device is very simple and can be very cheap, since the microfluidic analysis channel and the absorbent regions may be manufactured from materials that are abundant, cheap and biodegradable such as, for example, fiber and cellulose-based materials such as paper.

Preferably, the microfluidic analysis channel may majorly comprise a material selected independently from the group consisting of hydrophilic polymer, textile fiber, glass fiber, cellulose and nitrocellulose; being especially preferred that such material is biodegradable.

Furthermore, the receiving and collecting absorber regions are preferably made of a material selected from a paper based material, a fiber based material and a nitrocellulose based material.

In either embodiment of the present invention, any cathode and any anode coupled to the microfluidic analysis channel may comprise a material mainly selected from the group consisting of noble metal, non-noble metal, enzymes and bacteria. In case that any one of the electrodes comprises enzymes or bacteria, the pH of the medium can be acidic, basic or neutral depending upon the stability of these enzymes or bacteria at different pH. Preferably, the pH of the medium is one in which the metals, enzymes or bacteria present in any one of the electrodes have a higher stability and catalytic activity. To obtain this optimum pH is possible to immobilize suitable substances within the fuel cell.

Preferably, the analysis device as described in the present invention may be an analysis test strip, more preferably may be a test strip known as “lateral flow test strip”.

In an embodiment, the analysis device also includes a conductive track (or first conductive track) to connect the anodic zone and the cathodic zone of the analysis device with at least one electronic circuit. The electronic circuit is connected via another conductive track (or second conductive track) to the sensor included in said detection zone. The electronic circuit is also connected to a display system to visualize the results of the analysis.

The electronic circuit and the display system may be integrated in an independent unit connectable via the above described conductive tracks to the analysis device.

The sensor included in the detection zone may be an electrochemical, an optical, a piezoelectric, a magnetic, a surface plasmon resonance, a sonic acoustic wave or a mass spectroscopy sensor.

In an embodiment, the sensor can be formed by two separated parts, a first part that operates as a detector and a second part that operates as a transducer. Both parts can be included in the analysis device or alternatively, the second part operating as a transducer can be included in said independent unit.

In other embodiments of the invention, each electrochemical sensor of the analysis device may be based on carbon electrodes. This type of material for the electrochemical sensors also contributes significantly to make the analysis device of the invention more biodegradable.

In other embodiments of the invention, the electronic circuit of analysis device may be a silicon-based microelectronic circuit or a printed electronic circuit. Additionally, the display system may be a screen, for instance a screen printed on paper, A Liquid Cristal Display (LCD), an organic light-emitting diode (OLED) or an electrochromic display.

In other embodiments of the invention, the conductive tracks of the analysis device may be made of carbon. This type of material for the conductive tracks can make the analysis device highly biodegradable.

In yet other embodiments of the invention, the analysis device further includes a wireless communication module (Bluetooth, NFC, RF, etc.) to communicate a result of an analysis performed by the analysis device to an external receptor.

### BRIEF DESCRIPTION OF THE DRAWINGS

The previous and other advantages and features will be more fully understood from the following detailed description of embodiments, with reference to the attached figures, which must be considered in an illustrative and non-limiting manner, in which:

FIG. 1a-1d: Schematic representations of a top view of a fuel cell that can be used in an analysis device, according to different embodiments.

FIGS. 2a-2c: Schematic representations of a top view of a lateral flow test strip according to embodiments where two microfluidics channels are used.

FIG. 3a: Schematic representation of catholyte and anolyte fluids flowing through a microfluidic channel as shown in FIG. 1b.

FIG. 3b: Schematic representation of a 3D configuration of a microfluidic channel and coupled cathodic and anodic zones, through which catholyte and anolyte fluids flow.

FIG. 3c: Schematic representation of catholyte, anolyte and electrolyte fluids flowing through a microfluidic channel as shown in FIG. 1c.

FIG. 4a: Schematic representation of a top view of an analysis device for a liquid sample according to an embodiment of the invention. In this case, a single microfluidic analysis channel is used, thereby simplifying the above described configurations.

FIG. 4b: Schematic representation of a top view of an analysis device for a liquid sample according to an embodiment of the invention. In this case a single microfluidic channel is also used; however electronic circuit and display system are integrated in an independent unit connectable to the analysis device.

FIG. 5a: Schematic representation of a top view of an analysis device for a liquid sample according to an embodiment of the invention. In this case, detection zone of the analysis device is formed by a first part operating as a detector and a second part operating as a transducer.

FIG. 5b: Schematic representation of a top view of an analysis device for a liquid sample according to an embodiment of the invention. In this case, detection zone is also formed by two different elements, a detector and a transducer; however the transducer element is included in an independent unit together with electronic circuit and display system.

FIGS. 6a and 6b: Schematic representation of an example of the proposed analysis device, in particular when being an autonomous glucometer.

FIGS. 7a and 7b: Schematic representation of an example of the proposed analysis device, in particular when being an autonomous lateral flow reader.

FIG. 8: Schematic representation of a top view of an analysis device for a liquid sample according to an embodiment of the invention. In this case, a single microfluidic analysis channel is used and a wireless communication module is included to communicate the result of the analysis.

### DETAILED DESCRIPTION OF PREFERRED EMBODIMENTS OF THE INVENTION

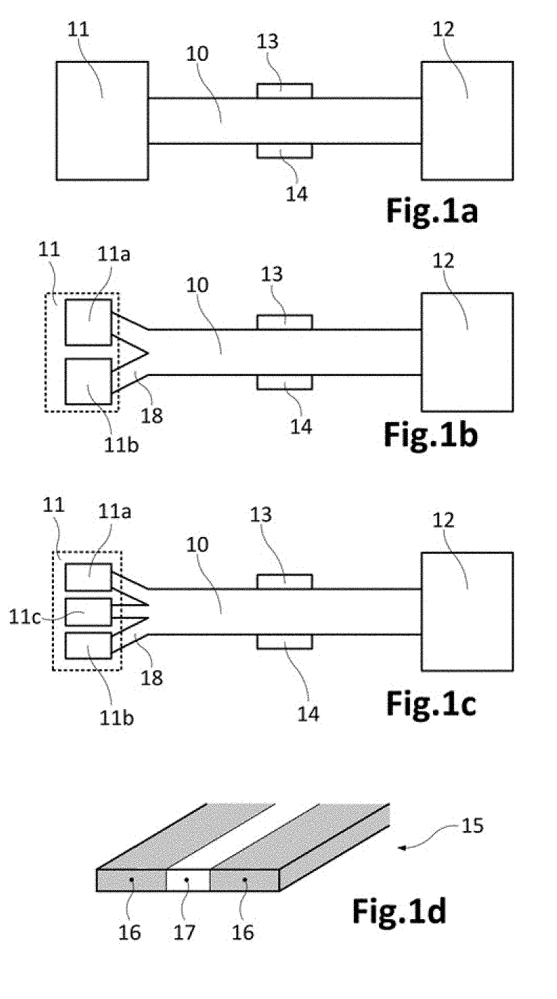

FIG. 1a shows a schematic representation of a top view of a fuel cell. This fuel cell comprising a microfluidic channel (10), a receiving absorbent region (11) coupled to the microfluidic channel (10) at one end of said microfluidic channel (10), and a collecting absorbent region (12) coupled to the microfluidic channel (10) at the opposite end of said channel. In order to facilitate capillary action through the microfluidic channel, it is preferred that the end which is coupled to the collecting absorbent region (12) and the end to which is coupled the receiving absorbent region (11) are located at different heights, remain indifferent which end is higher.

This particular configuration of the fuel cell allows to deposit in the receiving absorbent region (11) at least one suitable fluid for electricity generation, i.e. a fluid comprising fuel reactants. As well as allowing the flow of these fluids by capillary action through the microfluidic channel (10), until reaching the collecting absorbent region (12) where fluids are absorbed, thereby allowing the continued flow through the microfluidic channel (10).

The fuel cell of FIG. 1a also comprises a cathodic zone comprising at least one cathode (13) and an anodic zone comprising at least one anode (14) coupled to the microfluidic channel (10) so that the cathodic zone (13) and the anodic zone (14) can generate electrochemical energy due to its interaction with at least one fluid comprising fuel reactants when these flow continuously through the microfluidic channel (10) by capillary action. In this embodiment, the fluid deposited in the single receiving absorbent region may comprise reducing and oxidizing species, such that the interaction of the cathodic zone (13) with the reducing species and interaction of the anodic zone (14) with the oxidizing species may lead to an electrochemical voltage between the cathodic zone (13) and the anodic zone (14). In this particular embodiment, the cathodic zone (13) is placed on a lateral side of the microfluidic channel (10), and the anodic zone (14) is placed on the opposite side of the microfluidic channel (10).

Still referring to FIG. 1a, the receiving absorbent region (11) may comprise at least one chemical substance which has been previously immobilized in a defined area of the receiving absorbent region (11), so that the substance can be dissolved by adding an external liquid, preferably an aqueous liquid.

FIG. 1b is a schematic representation of a top view of another fuel cell. This configuration is very similar to the configuration of FIG. 1a with the difference that the receiving absorbent region (11) comprises two receiving absorbent sub-regions, identified as (11a) and (11b) which are separated from each and located in the same physical support. In the first receiving absorbent sub-region (11a) can deposited a catholyte fluid, giving rise to reduced species to interact with the cathodic zone (13), and in the second receiving absorbent sub-region (11b) can be deposited anolyte fluid comprising oxidizing species that can interact with the anodic zone (14). Alternatively, the first receiving absorbent sub-region (11a) may comprise an oxidizing substance previously immobilized in an area of the first receiving absorbent sub-region (11a) and the second receiving absorbent sub-region (11b) may comprise a reductive substance previously immobilized in an area of the second receiving absorbent sub-region (11b). Then, immobilized oxidizing and reducing substances can be solubilized for example by the addition of an external liquid, preferably an aqueous liquid.

In the embodiment of FIG. 1b, the microfluidic channel (10) comprises two branches (18), so that the receiving absorbent sub-region (11a) is coupled to the microfluidic channel (10) through one of these branches (18) and the second receiving absorbent sub-region (11b) is coupled to the microfluidic channel (10) through a second of said branches (18). Said first branch and the cathodic zone (13) are arranged substantially on the same side of the microfluidic channel (10), so that the cathodic zone (13) can substantially interact completely with the catholyte fluid when it flows through the microfluidic channel (10). Equivalently, the second branch and the anodic zone (14) are arranged substantially on the same side of the microfluidic channel (10), so that the anodic zone (14) can substantially interact completely with anolyte fluid when it flows through the microfluidic channel (10). More details about the flows of the catholyte and anolyte fluids are described later.

The configuration described in the previous paragraph implies a relative positioning between the first receiving absorbent sub-region (11a) and the cathodic zone (13), and between the second receiving absorbent sub-region (11b) and the anodic zone (14), which allows the production of electrochemical energy more efficiently than in the embodiment of FIG. 1a. In fact, with this configuration of the fuel cell a “clean” interaction between the catholyte fluid comprising at least one reducing species and the cathodic zone (13), and a “clean” interaction between the anolyte fluid comprising at least one oxidizing species and the anodic zone (14) can be obtained, consequently the fuel cell is more efficient.

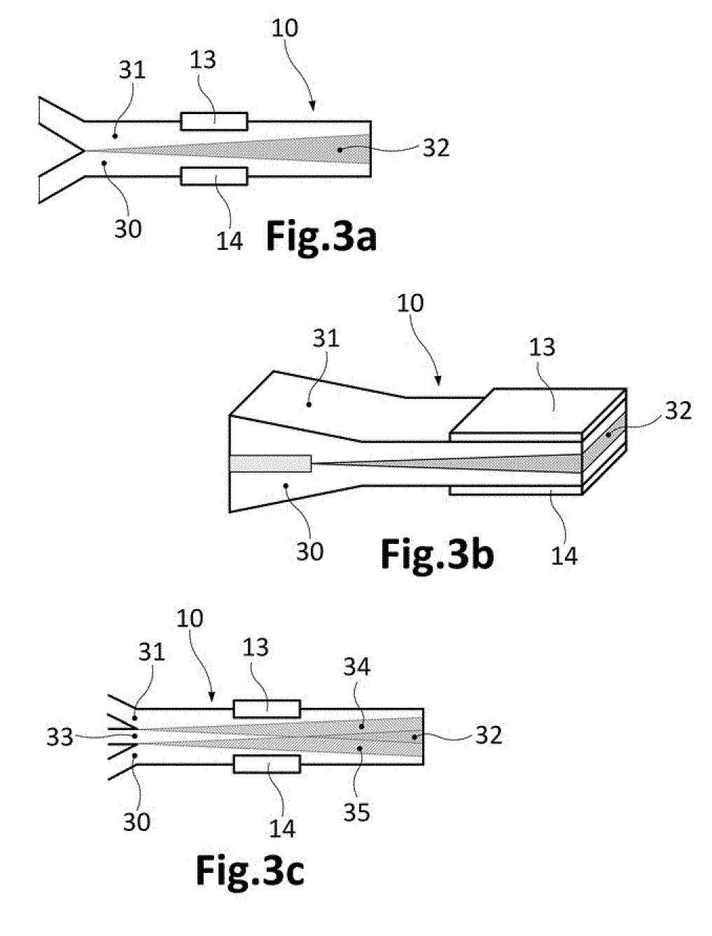

In this regard, FIG. 3a shows the configuration of a microfluidic channel (10), a cathodic zone (13) and an anodic zone (14) similar to the one comprised in the fuel cell shown in FIG. 1b. FIG. 3a also shows how a catholyte fluid (31) and an anolyte fluid (30) can flow through the microfluidic channel (10). Particularly, the catholyte fluid (31), which comprises reducing species, can flow so that it can achieve a substantially complete interaction between this and the cathode(s) contained in the cathodic zone (13). Equivalently, the anolyte fluid (30), which comprises oxidizing species can flow so that it can achieve a substantially complete interaction between this and the anode(s) contained in the anodic zone (14).

FIG. 3a also shows how, in this particular embodiment, the catholyte fluid (31) and the anolyte fluid (30) can start to mix after advancing a certain distance, forming an area called diffusion zone (32). In this particular embodiment, the cathodic zone (13) and the anodic zone (14) are positioned in the microfluidic channel (10) at a distance sufficiently short with respect to the end where the receiving absorbent sub-regions (11a) and (11b) are coupled to prevent that the diffusion zone (32) comes into contact with any one of the cathodes comprised in the cathodic zone (13), with any one of the anodes comprised in the anodic zone (14), or both. Thus, although the catholyte fluid (31) and the anolyte fluid (30) can be finally mixed, in this embodiment it is ensured an interaction between the fluid completely catholyte (31) and the cathodic zone (13), and between the fluid completely anolyte (30) and the anodic zone (14).

FIG. 3b is a schematic representation of a 3D microfluidic channel (10) and the configuration of the cathodic zone (13) and the anodic zone (14) in accordance with another embodiment. This configuration is an alternative to the configuration shown in FIGS. 1b and 3a. In this case, the first and second receiving absorbent sub-regions (11a), (11b), not shown in FIG. 3b, are arranged so that the flow of catholyte fluid (31) is achieved substantially above the flow of anolyte fluid (30). Accordingly, the cathodic zone (13) is disposed in an upper region of the microfluidic channel (10) and the anodic zone (14) is disposed in a lower region of the microfluidic channel (10). This configuration of FIG. 3b allows the generation of electrochemical energy substantially equal to the configuration of FIGS. 1b and 3a.

FIG. 1c is a schematic representation of a top view of another fuel cell. In this case, the difference from the fuel cell shown in FIG. 1b is that this embodiment further comprises a third receiving absorbent sub-region (11c) separated from the first and second receiving absorbent sub-regions (11a) and (11b). In this third absorbent sub-region (11c) can be deposited an electrolyte fluid, and may be disposed in relation to the first and second absorbent sub-regions (11a) and (11b) so that the electrolyte fluid maintains at least partially, the catholyte fluid (31) and the anolyte fluid (30) separate as they flow through the microfluidic channel (10) by capillarity.

In the embodiment of FIG. 1c, the mixture catholyte fluid (31) and the anolyte fluid (30) can be delayed with respect to the mixture which is produced in the configurations of FIGS. 1b, 3a and 3b. In this regard, FIG. 3c shows how an electrolyte fluid (33) flows between the catholyte fluid (31) and the anolyte fluid (30) to delay the mixing of the catholyte fluid (31) and the anolyte fluid (30). The area (34) refers to the mixture of catholyte fluid (31) with the electrolyte fluid (33). The area (35) refers to the mixture of anolyte fluid (30) with the electrolyte fluid (33). It is clearly seen that with the “intermediate” flow of electrolyte fluid (33), the diffusion zone (32) which represents the mixture of catholyte (31) and anolyte (30) fluids which appears later than in the embodiments without such “intermediate” flow of fluid electrolyte (33).

In any of the above described embodiments, the microfluidic channel (10) as well as any of the absorbent regions (11) and (12), can be made of a paper based material, such as for example filter paper, paper silk, cellulose paper, writing paper, etc. Alternatively, they may be made of other suitable materials such as e.g. nitrocellulose acetate, textiles, polymeric layers, etc. Paper-based materials suppose a low cost, so the microfluidic channel (10) and receiving and collecting absorbent regions, (11) and (12) respectively, are preferably made of such type of material. In addition, paper is a completely biodegradable material. Therefore, paper contributes to obtaining a cheap and biodegradable fuel cell.

Furthermore, the microfluidic channel (10), as well as any of the receiving or collecting regions comprising paper as a main material, can be obtained by two different methods, or a combination thereof. The first method involves cutting the paper into the desired shape so that the resulting structure corresponds to the microfluidic channel. The cutting can be performed by mechanical action, for example, using scissors, knives or automatic equipment such as a plotter cutter, or using a laser, etc. The second method involves defining hydrophobic areas within the total surface of the porous material, preferably paper. The definition of hydrophobic areas can be accomplished by impregnating the porous matrix with photoresist, wax, teflon, hydrophobic chemicals, etc., or applying a chemical treatment to modify the wetting properties.

FIG. 1d is a schematic representation of a 3D paper sheet having a microfluidic channel. The microfluidic channel has been achieved by defining hydrophobic areas (16) that define, in turn, a hydrophilic zone (paper) (17) which constitutes the desired microfluidic channel. The hydrophobic areas (16) can be obtained for example by applying any of the techniques discussed above.

Preferably, cutting is applied to obtain the microfluidic channel (10) and receiving and collecting absorbent regions, (11) and (12) respectively, because cutting a priori is cheaper than other types of methods, such as for example the techniques discussed above based on the definition of hydrophobic areas.

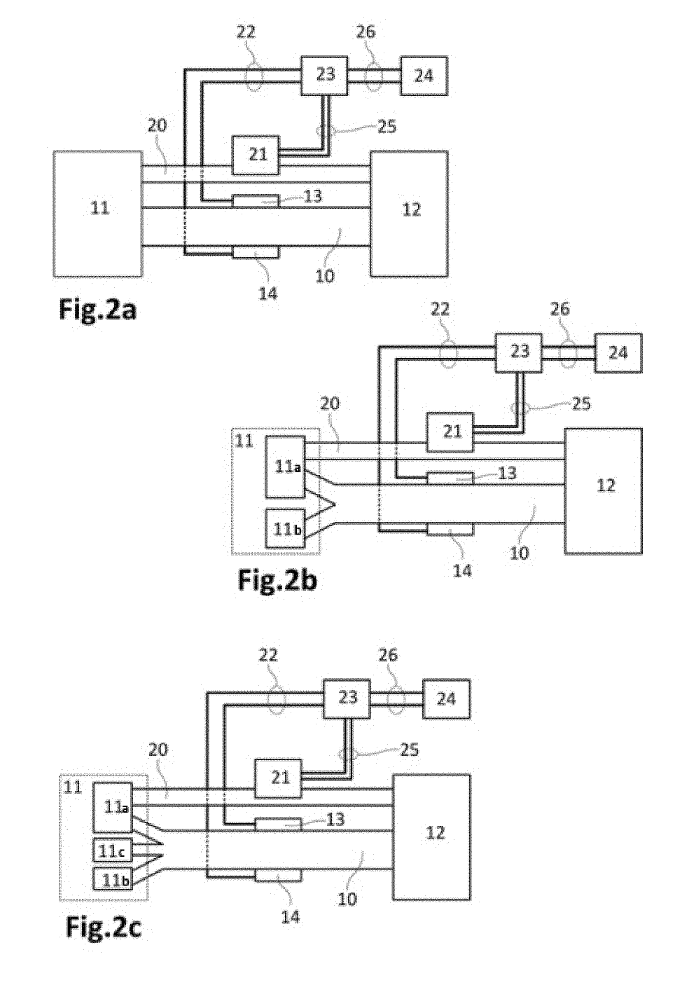

FIG. 2a is a schematic representation of a top view of a lateral flow test strip according to an embodiment. This test strip comprising the fuel cell described above and schematized in FIG. 1a. This test strip also comprises an analysis microfluidic channel (20) connected to the receiving absorbent region (11) at one end of the channel (20), and the collecting absorbent region (12) at the opposite end of channel (20). Thus, in this embodiment, the receiving absorbent region of the analysis microfluidic channel (20) is the same as the receiving absorbent region of the fuel cell, and the collecting absorbent region of the analysis microfluidic channel is the same as the collecting absorbent region of the fuel cell. The features described in relation to FIG. 1a with respect to the receiving absorbent region (11) and to the microfluidic channel (10) are also applicable to this embodiment of the test strip of the invention. Therefore, this especial configuration can also allow a continuous flow of fluid from the receiving absorbent region (11) to the collecting absorbent region (12), where the fluid is absorbed allowing the continuation of the flow by capillarity when the analysis microfluidic channel (20) is saturated.

Alternatively to the embodiment described above, the test strip may comprise a receiving absorbent region and a collecting absorbent region, connected to opposite ends of the analysis microfluidic channel (20), being these absorbent regions separated from receiving (11) and collecting (12) absorbent regions coupled to the microfluidic channel (10) which form part of the fuel cell comprised in the test strip.

In an embodiment as shown in FIG. 2a, the test strip comprises a detection zone (21) having at least one electrochemical sensor coupled to the analysis microfluidic channel (20), so that the electrochemical sensor may interact with the sample to be tested, preferably a biological sample, when it flows by capillary through analysis microfluidic channel (20). Such interaction, in combination with appropriate electrical input signals, can produce corresponding electrical output signals representing the results of the test. Electrochemical sensors can be based on carbon electrodes, said material contributes to the biodegradability of the test strip.

This test strip can also comprise an electronic circuit (23), a display system (24), preferably a screen, and a plurality of conductive tracks (22), (25) and (26) that connect the electronic circuit (23) with the anodic zone (14) and the cathodic zone (13) of the fuel cell, with the detection zone (21), and with the display system (24). The electronic circuit (23) may be a silicon-based microelectronic circuit. Additionally, the display system (24) can be a screen printed in paper, for example, based on suitable polymers. Additionally, the conductive tracks (22), (25) and (26) may be made of carbon. These features can make the test strip highly biodegradable. As an alternative to carbon, the conductive tracks (22), (25) and (26) may be made of conductive polymers, metals such as copper or gold metals, or any combination thereof.

Conductive tracks (22) that connect the electronic circuit (23) with the anodic zone (14) and the cathodic zone (13) of the fuel cell allow the electronic circuit (23) to receive electricity from the fuel cell. Conductive tracks (25) that connect the electronic circuit (23) with electrochemical sensors included in the detection zone (21) allow the electronic circuit (23) to provide adequate electrical input signals to the electrochemical sensors (21). The electronic circuit (23) can get these electrical input signals, necessary for electrochemical sensors (21) to properly interact with the sample to analyze, from the electricity produced by the fuel cell according to an implemented logic. This interaction of electrochemical sensors (21) with the sample, preferably biologic, and the appropriate electrical input signals can produce electrical output signals representing the results of the analysis. Sensors within the detection zone (21) can send these electrical output signals to the electronic circuit (23) through the corresponding conductive tracks (25). The electronic circuit (23) can convert, according to an implemented logic, these electrical output signals into electrical signals that can be visualized and sends them to the display system (24) through the corresponding conductive track (26).

The test strip may further comprise a pre-treatment region, not shown in FIG. 2a, which can be coupled to the microfluidic channel of the fuel cell (10) at a point between the receiving absorbent region (11) and the cathodic (13) or anodic (14) zones. Additionally, this pre-treatment region may also be incorporated into the microfluidic channel analysis (20), at a point between the receiving absorbent region of the sample (11) and the detection zone (21). This pre-treatment region may have a configuration suitable for carrying out different types of pretreatments such as filtering, separation, screening of the liquid(s) that may flow through the microfluidic channel of the fuel cell (10) and/or analysis microfluidic channel (20). To design and/or build this region known principles of pre-treatment can be used, such as those described in patent applications WO 2009121041 A2 (A. Siegel et al) and WO 2011087813 A2 (P. Yager et al).

FIG. 2b is a schematic representation of a top view of a lateral flow test strip in accordance with other embodiments of the invention. This test strip is very similar to the strip shown in FIG. 2a, with the difference that the strip of FIG. 2b includes a fuel cell of the type described with reference to FIG. 1b, while the strip FIG. 2a comprises a fuel cell of the type shown in FIG. 1a.

FIG. 2c is a schematic representation of a top view of a lateral flow test strip in accordance with other embodiments of the invention. This test strip is very similar to the strip shown in FIG. 2b, with the only difference that the strip of FIG. 2c comprises a fuel cell of the type described with reference to FIG. 1c, while the strip FIG. 2b comprises a fuel cell of the type shown in FIG. 1b.

An important aspect of the strips illustrated in FIGS. 2a, 2b and 2c is that the same fluid can be used as a suitable fluid to generate electricity by the fuel cell, and as the sample to analyze in the detection zone (21). This fluid can be a biological sample, such as, for example, urine, blood, blood plasma, saliva, semen, sweat, etc. In this way, this strip may be a completely stand-alone test strip, and therefore, operate without connection to external electrochemical sensor, display system or electronic circuit.

In some embodiments of the test strip described in this patent application, the detection zone (21) has the function of measuring or detecting specific compounds in the sample, preferably biologically, to analyze. Detection can be based on different techniques such as electrochemical, optical, etc. Additional stages of pre-treating the sample, and the regions needed for these steps to take place in the strip can be included before the sample reaches the detection zone (21).

An electrochemical sensor can be manufactured for example by deposition of one or more electrodes, which may be made of carbon in a porous matrix which may be made of paper based materials. One of these electrodes can be defined as a reference electrode, at least one of these electrodes as a counter electrode, and at least one more of these electrodes as a working electrode. Electrode deposition may be accomplished by various techniques such as sputtering, evaporation, spray coating or printing techniques such as ink jet, gravure, offset, flexographic or screen printing. The electrodes can be functionalized to enhance detection capabilities. The functionalization of the electrodes may be formed by deposition of an active material, chemical treatment, etc.

For designing and constructing the detection zone (21) can be used suitable known principles known to one skilled in the art, for example, those disclosed in Patterned paper substrates and as alternative materials for low-cost microfluidic diagnostics, David R. Ballerini, Xu Li and Shen Wei. Microfluidics and Nanofluidics. 2012, DOI: 10.1007/s10404-012-0999-2.

The electronic circuit (23) may correspond to an electronic circuit that can perform various tasks related to the test results to be produced. The circuit may comprise a combination of discrete electronic components and/or integrated circuits. Some embodiments may use, for example, a full custom application specific integrated circuit (ASIC) for performance improvement and reduction of area.

The circuit may comprise several blocks such as power management, instrumentation, communications, data logging, etc. The power management block may take the energy produced by the fuel cell and increase the voltage to power the block instrumentation. The instrumentation block can supply power to the sensors included in the detection zone (21) for performing the measurement, monitor the signal(s) of the sensors and compare them with reference values. The result(s) of the measurement(s) can be sent to the display system (24).

The electronic circuit (23) may further comprise a data logger to store the information collected from the sensors within the detection zone (21). Furthermore, the electronic circuit (23) may further comprise a communication module to send the result(s) of the measurement(s) by radiofrequency, e.g. to an external receiver.

For designing and constructing the electronic circuit (23), preferably when it is a microelectronic circuit, can be used suitable known principles known to one skilled in the art, for example, those disclosed in J. Alley Bran, Larry R. Faulkner, “Electrochemical Methods: Fundamentals and Applications”, John Wiley & Sons, 2001, ISBN 0-471-04372-9, Jordi Colomer-Farrarons, Pere Lluís Miribel-Català, “A Self-Powered CMOS Front-End Architecture for Subcutaneous Event-Detection Devices: Three-Electrodes amperometric biosensor Approach”, Springer Science+Business Media BV, 2011, ISBN 978-94-007-0685-9.

The display system (24) may allow the test strip of the present invention to show a visual indication of the result of the measurement. This signal can be demonstrated by using a screen, for example electro-chromic, light emitting diode, LCD, etc. Some of these display systems are described in CG Granqvist, electrochromic devices, Journal of the European Ceramic Society, Volume 25, Issue 12, 2005, pages 2907-2912; Fundamentals of Liquid Crystal Devices, Author(s): Deng-Ke Yang, Shin-Tson Wu Published Online: 19 Oct. 2006, DOI: 10.1002/0470032030.

In a particular embodiment, the display of the results may be due to a change of color produced by an electrochemical composite absorbed in a porous matrix (e.g., Prussian blue, etc.) comprised in the test strip.

The above described configurations can be simplified if the two microfluidic channels, analysis microfluidic channel (20) and microfluidic channel (10) are merged in one, namely microfluidic analysis channel (15). The microfluidic analysis channel (15) may comprise a material including a hydrophilic polymer, a textile fiber, a glass fiber, cellulose and nitrocellulose; being especially preferred that such material is biodegradable.

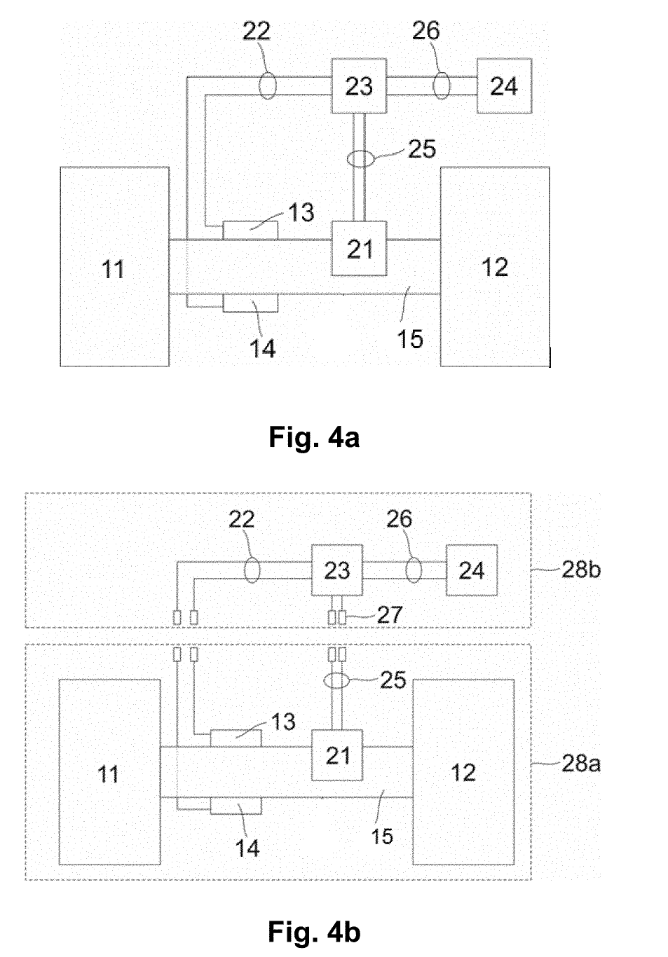

FIG. 4a shows a schematic representation of this simplified configuration. As can be seen in FIG. 4a, the analysis device comprises a single microfluidic analysis channel (15) where the cathodic zone (13) comprising at least one cathode and the anodic zone (14) comprising at least one anode are coupled to said microfluidic analysis channel (15). This microfluidic analysis channel plays the role of an analysis channel (equivalently to the microfluidic channel (20) described before) with a detection zone (21) having a sensor. Conductive tracks (22), (25) and (26) connect the electronic circuit (23) with the anodic zone (14) and the cathodic zone (13), with the detection zone (21) and with the display system (24). The electronic circuit (23) may be a silicon-based microelectronic circuit or a printed electronic circuit. Additionally, the display system (24) can be a screen printed in paper, for example, based on suitable polymers, an OLED or an electrochromic display. Additionally, the conductive tracks (22), (25) and (26) may be made of carbon. As an alternative to carbon, the conductive tracks (22), (25) and (26) may be made of conductive polymers, metals such as copper or gold metals, or any combination thereof.

This particular embodiment has several advantages compared to previous ones: it allows reducing the volume of the sample required both to generate power and to perform the analysis; it simplifies the analysis device design and the amount of material required for its fabrication; and it simplifies fabrication processes leading to higher cost-effectivity of the analysis device.

In another embodiment, see FIG. 4b, the proposed analysis device consist of two separated connectable parts; one part (28a) including a microfluidic analysis channel (15) with a detection zone (21) and a fuel cell on said microfluidic channel (15) comprising a receiving absorbent region (11), a collecting absorbent region (12), a cathodic zone (13) and an anodic zone (14), and another part (28b) including an electronic circuit (23) and a display system (24). When the analysis is to be performed, the two separated parts (28a, 28b) are connected to each other through connection regions (27). This particular embodiment presents the following advantages:
Electronic circuit (23) and display part (24) can be reused several times, which is more eco-friendly and cost-effective than single-use embodiments.
Integrating the fuel cell with the detection zone (21) in a separated part allows adjusting the fuel cell to generate power for a single analysis. In this way, power is always available to perform the test. There is no need to plug the electronics part neither to any external power source nor any additional battery.

The sensor included in the detection zone may comprise any of an electrochemical, an optical, a piezoelectric, a magnetic, a surface plasmon resonance, a sonic acoustic wave or a mass spectroscopy sensor.

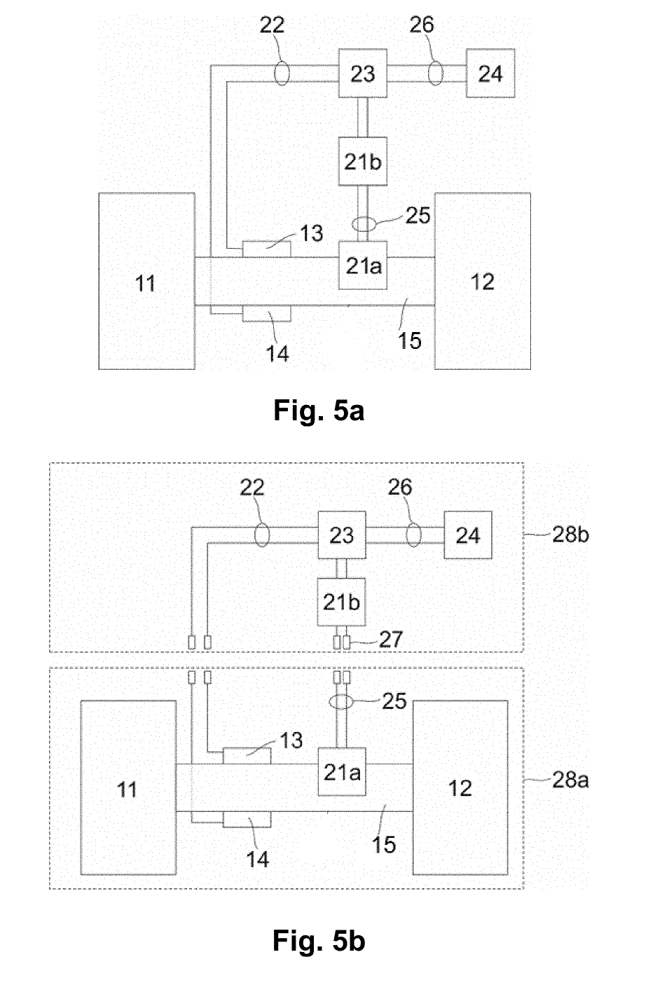

FIGS. 5a and 5b show other embodiments of the analysis device. In this case, detection zone (21) is formed by two separated parts, a first part that operates as a detector (21a) and a second part that operates as a transducer (21b). Both parts can be included in the analysis device or alternatively, the first part operating as a detector (21a) can be included in consumable part (28a) whereas the second part operating as a transducer (21b) can be included in said reusable part or independent unit (28b). In this last case detection zone (21) is physically divided into two parts until the measurement is made, all connections are made as shown in FIG. 5b.

In any of the above described embodiments of FIGS. 4a, 4b, 5a and 5b, the absorbent regions (11) and (12) can comprise one or more sub-regions, as described in FIGS. 1b, 1c, 2b and 2c. The receiving and collecting absorber regions can be made of a material selected from a paper based material, a fiber based material and a nitrocellulose based material.

Following different exemplary embodiments are described.

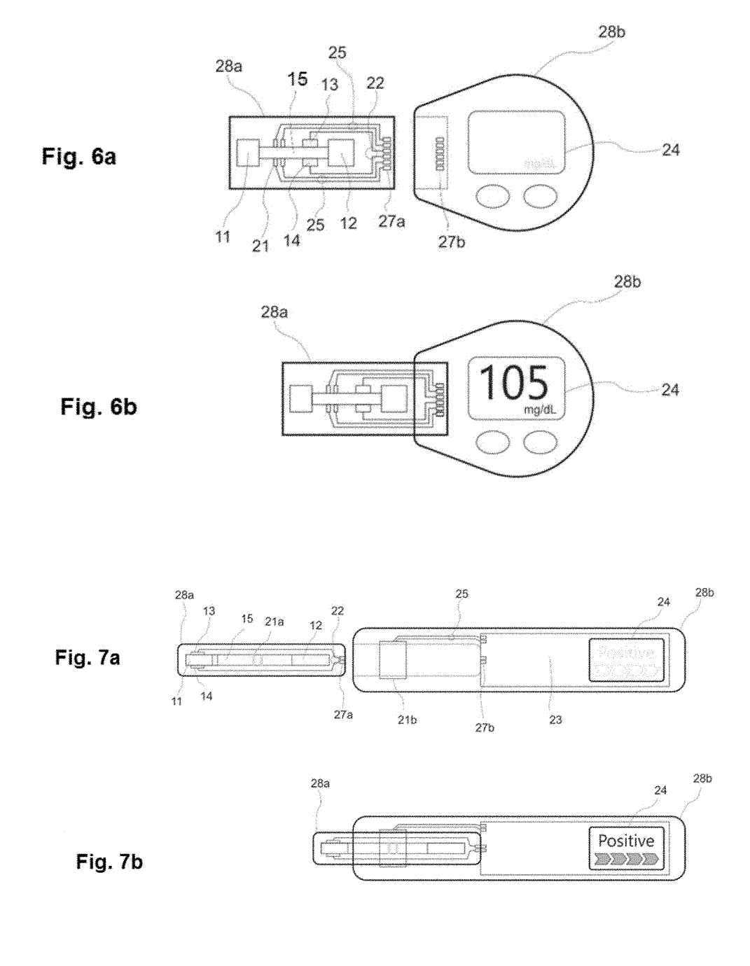

FIGS. 6a and 6b illustrate an example of the proposed analysis device working as autonomous glucometer. The autonomous glucometer is comprised by two parts: an electronic reader (28b) and a disposable test strip (28a) as shown in FIG. 6a. The electronic reader includes electronics module (23) and display system (24). On the other side, the disposable test strip (28a) includes electrochemical sensors and power source. The test strip (28a) has a sample receiving absorbent region (11), a microfluidic analysis channel (15) and a collecting absorbent region (12). The microfluidic analysis channel (15) comprises a detection zone (21) to measure the concentration of glucose in the sample using electrochemical sensors. The microfluidic analysis channel (15) also includes a power source with cathodic zone (13) and anodic zone (14) that is capable of producing electrical energy upon addition of the sample. The sensors and the anodic and cathodic zones (13, 14) are connected by conductive tracks (22, 25) to a connector zone (27a) in the disposable strip. In order to perform a measurement, the disposable test strip is inserted into the electronic reader (28b) as shown in FIG. 6b, so that the connector zone (27a) in the disposable strip (28a) are in electrical contact with the connectors (27b) in the connector zone in the electronic reader (28b). When a sample is added to the test strip, the power source provides electrical energy to the electronics module (23) to perform the measurement, reading the signal from the sensors in the detection zone (21) and show the results in the display (24).

FIGS. 7a and 7b illustrate an example of the proposed analysis device working as autonomous lateral flow reader. The autonomous lateral flow reader is comprised by two parts: an electronic reader (28b) and a disposable lateral flow test strip (28a) as shown in FIG. 7a. The electronic reader (28b) includes a reader detection zone (21b), electronics module (23) and display system (24). On the other side, the disposable lateral flow test strip includes a test strip detection zone (21a) and power source. The disposable test strip includes an immunoassay lateral flow fabricated using known manufacturing techniques. The lateral flow immunoassay comprises a sample receiving absorbent region (11) that includes dried reagents needed by the test, a microfluidic analysis channel (15) and a collecting absorbent region (12). The microfluidic analysis channel (15) comprises a test strip detection zone (21a) consisting in a reagents capture zone that defines test and control lines. The microfluidic analysis channel (15) also includes a power source with cathodic zone (13) and anodic zone (14) that is capable of producing electrical energy upon addition of the sample. The anodic and cathodic zones (13, 14) are connected by conductive tracks (22) to a connector zone (27a) in the disposable strip (28a). The immunoassay, power source, electric tracks and connectors are enclosed in a plastic housing to facilitate handling. In order to perform a measurement, the disposable test strip is inserted into the electronic reader as shown in FIG. 7b, so that the connector zone (27a) in the disposable strip (28a) is in electrical contact with the connectors (27b) in the connector zone in the electronic reader (28b). When a sample is added to the test strip, the power source provides electrical energy to the electronics module (23) to perform the measurement, reading the intensity of the lines developed in the strip detection zone (21a) using transducers in the reader detection zone (21b), and show the results in the display system (24).

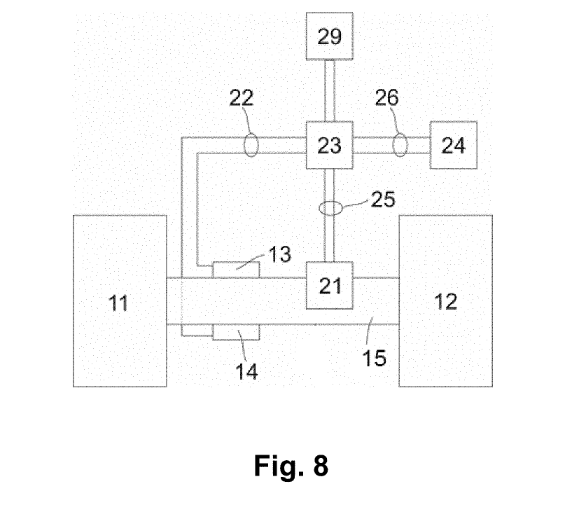

With reference to FIG. 8, therein it is illustrated another embodiment of the proposed analysis device. In this case, a wireless communication module 29 (Bluetooth, NFC, infrared, etc.) is included to communicate a result of an analysis performed by the analysis device to an external receptor.

The scope of the present invention is defined in the following set of claims.

1. An analysis device for a liquid sample, comprising:
one microfluidic analysis channel made of a wicking material with adequate porosity to allow capillary flow of at least one liquid sample suitable for generating electricity;
at least one receiving absorbent region coupled to said microfluidic analysis channel;
at least one collecting absorbent region coupled to said microfluidic analysis channel;
a cathodic zone formed by at least a cathode coupled to said analysis channel;
an anodic zone formed by at least an anode coupled to said microfluidic analysis channel; and
at least one detection zone having at least one sensor connected to said microfluidic analysis channel,
wherein each receiving absorbent region and each collecting absorbent region are connected to the microfluidic analysis channel, thereby when a liquid sample is deposited in the receiving absorbent region it flows by capillary action through the microfluidic analysis channel to reach the collecting absorbent region where it is absorbed, and
wherein the sensor interacts with the liquid sample to be tested, when said sample flows by capillarity through the microfluidic analysis channel.

2. The analysis device of claim 1, further comprising a first conductive track connecting the anodic zone and the cathodic zone of the analysis device with at least one electronic circuit connected via a second conductive track to at least one element selected from the group consisting of one electrochemical, optical, piezoelectric, magnetic, surface plasmon resonance, sonic acoustic wave or mass spectroscopy sensor included in said detection zone, and said electronic circuit being also connected to at least one display system to visualize the results of the analysis.

3. The analysis device of claim 2, wherein said electronic circuit and display system are integrated in an independent unit connectable via said first and second conductive tracks to the analysis device.

4. The analysis device of claim 1, wherein said sensor coupled to the microfluidic analysis channel is an electrochemical, an optical, a piezoelectric, a magnetic, a surface plasmon resonance, a sonic acoustic wave or a mass spectroscopy sensor.

5. The analysis device of claim 4, wherein said sensor comprising two separated parts, a first part operating as a detector and a second part operating as a transducer.

6. The analysis device of claim 2, wherein said electronic circuit and display system are integrated in an independent unit, which is connectable via said first and second conductive tracks to the analysis device including said sensor, wherein the sensor comprises two separated parts, a first part operating as a detector and a second part operating as a transducer, wherein said second part is integrated into the independent unit and said first part is integrated into the analysis device.

7. The analysis device of claim 1, wherein the material of the microfluidic analysis channel is selected from the group consisting of paper, hydrophilic polymer, textile fiber, glass fiber, cellulose and nitrocellulose.

8. The analysis device of claim 1, wherein each of the regions receiving and collecting absorbers are made of a material selected from a paper based material, a fiber based material and a nitrocellulose based material.

9. The analysis device according to claim 4, wherein the sensor being an electrochemical sensor comprising carbon electrodes.

10. The analysis device according to claim 2, wherein the electronic circuit is a silicon-based microelectronic circuit or a printed electronic circuit.

11. The analysis device according to claim 2, wherein the display system to visualize the results of the analysis comprises a screen printed on paper, an LCD, an OLED or an electrochromic display.

12. The analysis device according to claim 2, wherein the conductive tracks are made of carbon.

13. The analysis device according to claim 1, further comprising a wireless communication module to communicate a result of an analysis performed by the analysis device to an external receptor.
